(19) United States
(12) Patent Application Publication
(10) Pub. No.: US 2026/0326236 A1
(43) Pub. Date: Oct. 22, 2026

(54) LASER CUTTING HEAD

(71) Applicant: WuHan Raycus Fiber Laser Technologies CO., LTD, Wuhan, Hubei (CN)

(72) Inventors: Qi YANG, Wuhan, Hubei (CN); Faping WANG, Wuhan, Hubei (CN); Mingfeng LIU, Wuhan, Hubei (CN); Jianhong SHI, Wuhan, Hubei (CN); Suqi XIA, Wuhan, Hubei (CN); Dapeng YAN, Wuhan, Hubei (CN)

(73) Assignee: WuHan Raycus Fiber Laser Technologies CO., LTD, Wuhan, Hubei (CN)

(21) Appl. No.: 18/994,160

(22) PCT Filed: May 20, 2024
(86) PCT No.: PCT/CN2024/094253

§ 371 Date: Jan. 14, 2025

(30) Foreign Application Priority Data
Nov. 6, 2023 (CN) 202311463409.2

(51) Int. Cl. B23K 26/14; B23K 26/064; B23K 26/70

(52) U.S. Cl. CPC B23K 26/1476; B23K 26/0648; B23K 26/703

(57) ABSTRACT

The present disclosure provides a laser cutting head, including an optical fiber connector, a first protection assembly, an optical module, a second protection assembly, and a nozzle blowing assembly. The nozzle blowing assembly includes a first sleeve, a first housing, and a nozzle. A first heat dissipation channel is formed between the first housing and the first sleeve. The first housing is provided with a cooling gas channel, a first inlet, a first outlet, and a first gas outlet. The first inlet and the first outlet are connected with the first heat dissipation channel, and the first gas outlet is connected with the cooling gas channel.

This application claims priority to the Chinese patent application NO. 202311463409.2 filed with the China Patent Office on Nov. 6, 2023. The entire content of the above application is incorporated herein by reference.

### TECHNICAL FIELD

The present application belongs to the field of laser processing technology, and particularly relates to a laser cutting head.

### BACKGROUND

A laser cutting machine utilizes a fiber laser generator as its light source. A fiber laser, as a new type of laser, can emit a high-energy-density laser beam, which may be focused onto a surface of a workpiece. This focused laser beam instantly melts and vaporizes an area of the workpiece on which an ultra-fine focus spot of the focused laser beam illuminates. By moving an irradiation position of the spot through a Computer Numerical Control (CNC) mechanical system, the machine achieves an automatic cutting. Such fiber laser cutting machine can perform both flat cutting and bevel cutting, delivering precise and smooth edges, making it suitable for high-precision cutting such as metal plate cutting.

A cutting head is an important component of the fiber laser cutting machine. When used in high-precision fields, the demands for seam quality of sheet cutting and a sheet cutting speed are getting higher and higher. In related technologies, generally, only a first housing of an optical module is subjected to heat dissipation treatment, resulting in an inadequate heat dissipation effect. As the laser power increases, the temperature of the cutting head rises, and heat dissipation at such a high temperature surpasses the capability of the existing heat dissipation design.

### SUMMARY

Embodiments of the present disclosure provide a laser cutting head and a laser cutting system to solve the problem that the existing cutting head only has a heat dissipation structure for the optical module which cannot meet the heat dissipation requirements.

The present disclosure provides a fixing bracket configured to fix a temperature sensor which collects a temperature of a battery cell in the battery module. The battery module includes a plurality of battery cells. The fixing bracket includes a bracket body. The fixing bracket includes a frame body having multiple sidewalls, wherein the sidewalls are arranged at an angle to each other. At least one of the sidewalls has an installation groove, wherein the installation groove is arranged to install the temperature sensor.

In an aspect, some embodiments of the present disclosure provide a lase cutting head, including: an optical fiber connector, a first protection assembly, an optical module, a second protection assembly, and a nozzle blowing assembly that are connected in sequence. The nozzle blowing assembly includes:
a first sleeve provided with a first light-transmitting and gas blowing channel;
a first housing sleeved on the first sleeve, wherein a first heat dissipation channel is formed between the first housing and the first sleeve, the first housing is provided with a cooling gas channel, a first inlet, a first outlet, and a first gas outlet, the first inlet and the first outlet are connected with the first heat dissipation channel, and the first gas outlet is connected with the cooling gas channel; and
a nozzle connected with the first housing, wherein the first light-transmitting and gas blowing channel is connected with the nozzle, and the first gas outlet is located on a side of the first housing adjacent to the nozzle.

### BENEFICIAL EFFECTS

The beneficial effects of this application are as follows. The laser cutting head provided by some embodiments of the present disclosure includes an optical fiber connector, a first protection assembly, an optical module, a second protection assembly, and a nozzle blowing assembly that are connected in sequence. The first protection assembly and the second protection assembly are respectively disposed on two sides of the optical module to prevent dust from entering the inside of the optical module from the two sides, avoiding affecting the performance of an optical lens, and thereby ensuring the reliability of the lase cutting head. The nozzle blowing assembly includes a first sleeve, a first housing, and a nozzle. A first heat dissipation channel is formed between the first housing and the first sleeve, and a cooling gas channel is provided in the first housing, so as to dissipate heat of the nozzle blowing assembly simultaneously through liquid cooling and gas cooling, achieving a good heat dissipation effect. The laser cutting head is suitable for high-power lasers, overcomes the problem that the existing cutting head only has a heat dissipation structure designed on a housing of the optical module which cannot meet some heat dissipation needs, and therefore has good heat dissipation effect and cutting performance and is suitable for the high-power lasers.

### BRIEF DESCRIPTION OF THE DRAWINGS

In order to explain technical solutions in some embodiments of the present disclosure more clearly, the following will briefly introduce the drawings needed for describing the embodiments. Apparently, the drawings in the following description are only some embodiments of the present disclosure. For those skilled in the art, other drawings can be obtained based on these drawings without exerting creative efforts.

In order to have a more comprehensive understanding of the present disclosure and its beneficial effects, the following description will be made in conjunction with the accompanying drawings. The same reference numerals in the following description represent the same parts.

FIG. 1 is a perspective view of a laser cutting head according to some embodiments of the present disclosure.

FIG. 2 is a side view of a first protection assembly according to some embodiments of the present disclosure.

FIG. 3 is a cross-sectional view along a A-A direction in FIG. 2.

FIG. 4 is a schematic structural diagram of an aperture according to some embodiments of the present disclosure.

FIG. 5 is another side view of the first protection assembly according to some embodiments of the present disclosure.

FIG. 6 is an exploded view of the first protection assembly according to some embodiments of the present disclosure.

FIG. 7 is a side view of an optical module according to some embodiments of the present disclosure.

FIG. 8 is a cross-sectional view along a line B-B in FIG. 7.

FIG. 9 is a perspective view of a form of a collimation assembly according to some embodiments of the present disclosure.

FIG. 10 is a side view of FIG. 9.

FIG. 11 is a cross-sectional view along a line C-C in FIG. 10.

FIG. 12 is a perspective view of another form of the collimation assembly according to some embodiments of the present disclosure.

FIG. 13 is an exploded view of FIG. 12.

FIG. 14 is another side view of the optical module according to some embodiments of the present disclosure.

FIG. 15 is a cross-sectional view along a line D-D in FIG. 14.

FIG. 16 is a cross-sectional view along a line E-E in FIG. 14.

FIG. 17 is a perspective view of a second protection assembly according to some embodiments of the present disclosure.

FIG. 18 is a perspective cross-sectional view of the second protection assembly according to some embodiments of the present disclosure.

FIG. 19 is a perspective view of a nozzle blowing assembly according to some embodiments of the present disclosure.

FIG. 20 is a perspective cross-sectional view of the nozzle blowing assembly according to some embodiments of the present disclosure.

FIG. 21 is an exploded view of the nozzle blowing assembly according to some embodiments of the present disclosure.

FIG. 22 is a cross-sectional view of a first sleeve in the nozzle blowing assembly according to some embodiments of the present disclosure.

### EXPLANATION OF REFERENCE SIGNS

100—optical fiber connector; 200—first protection assembly; 210—first mounting base; 220—first protection lens; 230—aperture; 231—first light-transmitting channel; 232—light blocking surface; 233—fourth groove; 240—second heat dissipation channel; 241—second inlet; 242—second outlet; 250—first lens base; 300—optical module; 310—collimation assembly; 311—collimation lens; 312—collimation lens base; 3121—third heat dissipation channel; 3122—third inlet; 3123—third outlet; 313—sliding mechanism; 3131—guiding rail; 3132—sliding block; 3133—limiter; 3134—limiter fitting component; 314—driving mechanism; 3141—voice coil motor; 3142—magnetic scale; 3143—sensing component; 315—fixing bracket; 3151—motor fixing plate; 3152—coil fixing plate; 320—focusing assembly; 330—second housing; 331—fourth heat dissipation channel; 3311—water inlet channel; 3312—water outlet channel; 3313—fourth inlet; 400—second protection assembly; 410—lower mounting base; 411—first gas inlet; 412—second gas inlet-; 413—second communication groove; 420—upper mounting base; 430—second protection lens; 440—second lens base; 450—seal; 460—monitoring mounting plate; 470—second adapter block; 480—fifth heat dissipation channel; 500—laser cutting nozzle; 510—first sleeve; 511—first light-transmitting and gas blowing channel; 512—fin; 513—mounting hole; 514—third groove; 520—first housing; 521—cooling gas channel; 522—first inlet; 523—first outlet; 524—first gas outlet; 526—cone; 527—ceramic ring; 528—adapter block; 529—connection screw sleeve; 530—first heat dissipation channel; 540—nozzle; 550—first gas channel; 560—flow equalization block; 561—second light-transmitting and gas blowing channel; 562—second gas channel; 563—first groove; 564—second groove; 570—gas blowing cover; 571—first communication groove.

### EMBODIMENTS OF THE DISCLOSURE

The technical solutions in some embodiments of the present disclosure will be clearly and completely described below with reference to the accompanying drawings in the embodiments of the present disclosure. Apparently, the described embodiments are only some of the embodiments of the present disclosure, but not all of the embodiments. Based on the described embodiments in the present disclosure, all other embodiments obtained by those skilled in the art without making creative efforts fall within the scope of protection of the present disclosure.

Some embodiments of the present disclosure provide a laser cutting head applied to high-power fiber lasers, such as kilowatt-level high-power fiber lasers, to solve the problem that existing cutting head only has a heat dissipation structure for an optical module which cannot meet the heat dissipation requirements. The following will be described with reference to the accompanying drawings.

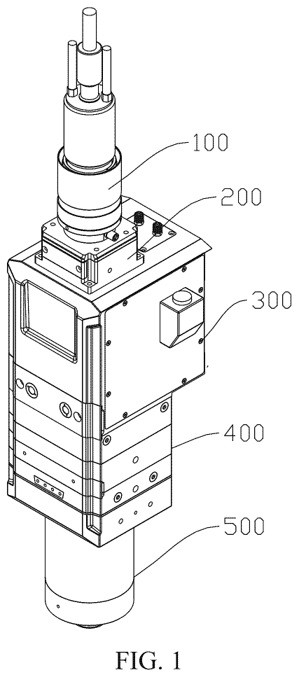

Referring to FIG. 1, the laser cutting head includes an optical fiber connector 100, a first protection assembly 200, an optical module 300, a second protection assembly 400, and a nozzle blowing assembly 500 that are connected in sequence.

In some embodiments of the present disclosure, the optical fiber connector 100 may be a Quick Beam (QB) connector, a Quick Beam Handle (QBH) connector, or a Quick Change (QC) connector, and is used to be connected with an output head of a fiber laser. A type of the fiber connector 100 is adapted to the output head of the fiber laser, so that a laser beam output from the fiber laser is guided into the laser cutting head.

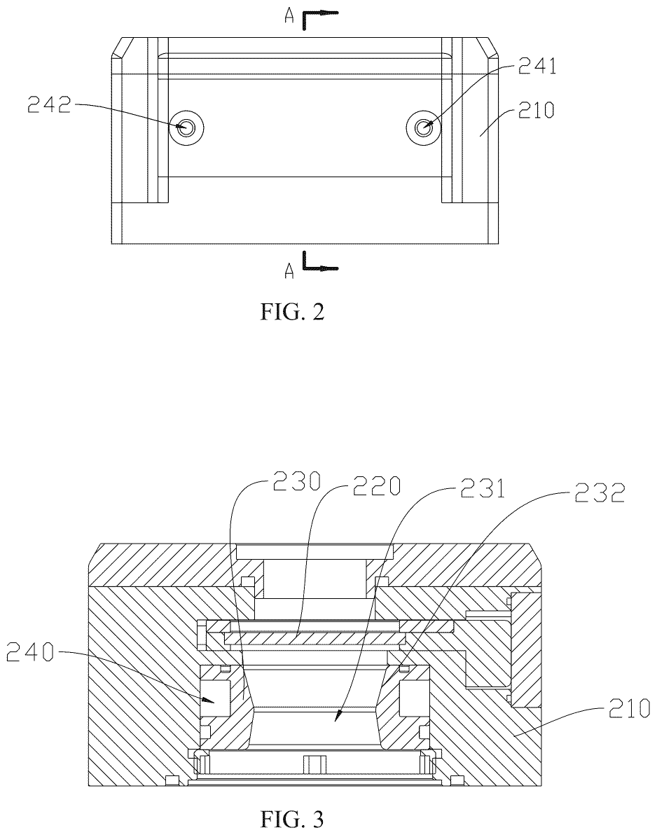

In some embodiments of the present disclosure, as shown in FIGS. 2 and 3, the first protection assembly 200 at least includes a first mounting base 210 and a first protection lens 220. The first protection lens 220 is detachably mounted on the first mounting base 210, which facilitates the replacement of the first protection lens 220, prevents dust from entering the optical module 300 from the optical fiber connector 100 side, protects the optical module 300, and improves the reliability of the optical module 300.

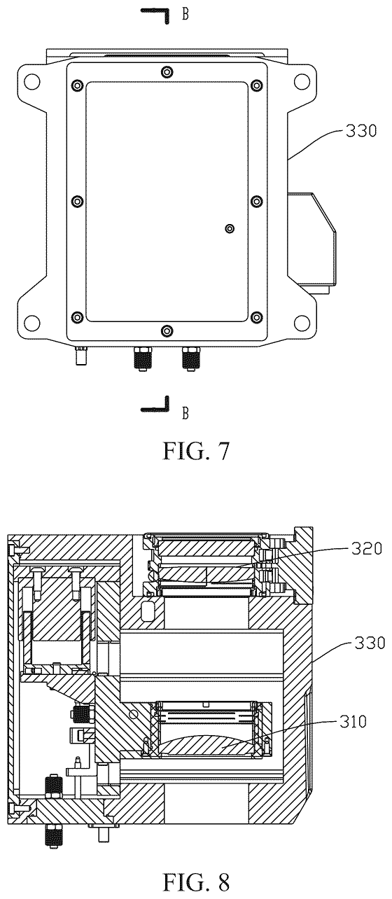

In some embodiments of the present disclosure, as shown in FIGS. 7 and 8, the optical module 300 at least includes a second housing 330, a collimation assembly 310, and a focusing assembly 320. The collimation component 310 and the focusing assembly 320 are both installed in the second housing 330. A collimation lens of the collimation assembly 310 and a focusing lens of the focusing assembly 320 are coaxially arranged, and the collimation lens is closer to the first protection assembly 200 than the focusing lens to the first protection assembly 200. The laser beam output by the fiber laser is collimated by the collimation assembly 310, then is focused by the focusing assembly 320, before being emitted from the nozzle blowing assembly 500 to perform laser cutting.

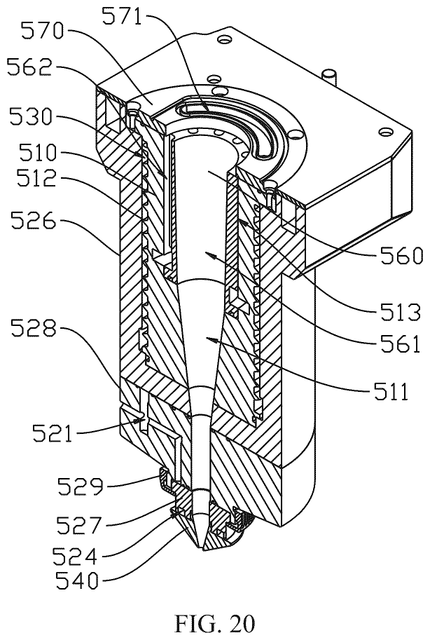

In some embodiments of the present disclosure, as shown in FIGS. 19 and 20, the nozzle blowing assembly 500 includes a first sleeve 510, a first housing 520, and a nozzle 540. The first sleeve 510 is a hollow structure with openings at both ends. A first light-transmitting and gas blowing channel 511 is provided in a center of the first sleeve 510. The laser beam after being collimated and focused by the optical module 300 passes through the first light-transmitting and gas blowing channel 511, and is emitted from the nozzle 540. The first light-transmitting and gas blowing channel 511 is further connected with an external gas source for transmitting pressurized gas. The pressurized gas blows away slag formed on a workpiece under the action of the laser, thereby forming a cutting path and completing laser cutting. The first housing 520 is sleeved on the first sleeve 510. A first heat dissipation channel 530 is formed between the first housing 520 and the first sleeve 510. The first heat dissipation channel 530 is connected with an external water cooler. Circulating cooling liquid is introduced into the first heat dissipation channel 530. The cooling liquid may be water, oil or a mixture of water and oil. The first housing 520 is provided with a cooling gas channel 521, a first inlet 522, a first outlet 523, and a first gas outlet 524. The first inlet 522 and the first outlet 523 are connected with the first heat dissipation channel 530, and the first heat dissipation channel 530 is connected with an external water cooling mechanism through the first inlet 522 and the first outlet 523. The cooling gas channel 521 is connected with an external cooling gas source. The first gas outlet 524 is connected with the cooling gas channel 521. The first gas outlet 524 is arranged on a side close to the nozzle 540, and cold gas directly acts on the nozzle 540 to dissipates heat of the nozzle 540. The first heat dissipation channel 530 is used to dissipate heat of the nozzle blowing assembly 500 to prevent a temperature of the nozzle blowing assembly 500 from being too high and affecting the surrounding optical module 300. The nozzle 540 is connected with a side of the first housing 520 away from the second protection assembly 400. The first light-transmitting and gas blowing channel 511 is connected with the nozzle 540. The first gas outlet 524 is located on a side of the first housing 520 close to the nozzle 540.

It can be understood that in the embodiments of the present disclosure, the first protection assembly 200 and the second protection assembly 400 are respectively provided on a light input side and a light output side of the optical module 300 to block two sides of the optical module 300 and prevent dust from entering the optical module 300, ensuring optical reliability of the collimation assembly 310 and focusing assembly 320 of the optical module 300, preventing the collimation assembly 310 and focusing assembly 320 from being burned by heat due to dust accumulation, and improving a service life of the optical lenses. In addition, in some embodiments of the present disclosure, the first heat dissipation channel 530 is formed between the first sleeve 510 and the first housing 520 of the nozzle blowing assembly 500, and the first heat dissipation channel 530 cools and dissipate the heat of the nozzle blowing assembly 500. The first housing 520 is further provided with the cooling gas channel 521 to cool the nozzle 540. Without the first heat dissipation channel 530, a temperature of the cooling gas in the cooling gas channel 521 will be relatively high due to the heat generated by the nozzle blowing assembly 500, which makes it impossible to cool and dissipate the heat of the nozzle 540, and the nozzle 540 is easily burned. Moreover, the nozzle blowing assembly 500 is adjacent to the optical module 300. If the temperature of the nozzle blowing assembly 500 is relatively high, the heat transferred to the optical module 300 will cause that a temperature of the optical module 300 becomes relatively high. This may burn out the collimation assembly 310 and the focusing assembly 320, and affects a service life of the optical module 300. Therefore, the embodiments of the present disclosure provide the laser cutting head(s) having an improved heat dissipation effect, suitability for high-power lasers, enhanced reliability, a guaranteed cutting effect, and suitability for precision instrument processing.

In some embodiments, as shown in FIGS. 20, 21, and 22, the nozzle blowing assembly 500 further includes a flow equalization block 560. A mounting hole 513 and the first light-transmitting and gas blowing channel 511 are provided inside the first sleeve 510. The mounting hole 513 is adapted to the flow equalization block 560. The mounting hole 513 is located above the first light-transmitting and gas blowing channel 511. The flow equalization block 560 is installed in the first sleeve 510. A second light-transmitting and gas blowing channel 561 is provided in the flow equalization block 560. The first light-transmitting and gas blowing channel 511 and the second light-transmitting and gas blowing channel 561 are interconnected. The first light-transmitting and gas blowing channel 511 and the second light-transmitting and gas blowing channel 561 are coaxial with the first sleeve 510. The second light-transmitting and gas blowing channel 561 is located above the first light-transmitting and gas blowing channel 511. A plurality of second gas channels 562 are formed between an outer wall of the flow equalization block 560 and an inner wall of the first sleeve 510. The plurality of second gas channels 562 are arranged at intervals along a circumferential direction of the flow equalization block 560. The second gas channels 562 extend along an axial direction of the first sleeve 510. The first sleeve 510 is provided with at least one first gas channel 550. Each first gas channel 550 extends along the axial direction of the first sleeve 510. A gas inlet of each first gas channel 550 faces the second protection assembly 400. A gas outlet of the second gas channels 562 faces the second protection assembly 400. An end of each first gas channel 550 away from the second protection assembly 400 is connected with an end of the second gas channel 562 away from the second protection assembly 400. The second gas channel 562 is interconnected with the second light-transmitting and gas blowing channel 561, and the second light-transmitting and gas blowing channel 561 is interconnected with the first light-transmitting and gas blowing channel 511.

It can be understood that the first gas channel 550 is connected with an external gas source. Along the radial direction of the first sleeve 510, the first gas channel 550 is located outside the second gas channel 562, and the second gas channel 562 is located outside the second light-transmitting and gas blowing channel 561. Gas enters the second gas channel 562 from the first gas channel 550, then enters the second light-transmitting and gas blowing channel 561, and then enters the nozzle 540 from the first light-transmitting and gas blowing channel 511. The gas undergoes multiple turns, compared with the gas directly entering the first light-transmitting and gas blowing channel 511 from the second light-transmitting and gas blowing channel 561, the gas in the embodiment is evenly dispersed, reducing internal pressure loss of the second light-transmitting and gas blowing channel 561 and the first light-transmitting and gas blowing channel 511, which maintains air pressure, improves a gas blowing effect, and ensures a satisfying shape of a cutting path.

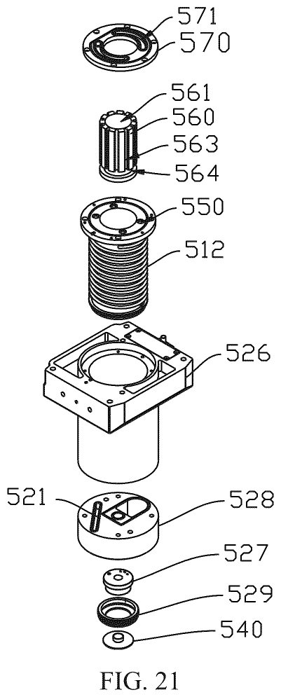

Based on the above embodiments, as shown in FIG. 21, the plurality of second gas channels 562 are arranged at equal intervals along the axial direction of the flow equalization block 560, and the number of the second gas channels 562 is greater than the number of the at least one first gas channel 550 to improve a pressure equalization effect. The more the second gas channels 562, the better the pressure equalization effect.

Based on the above embodiments, as shown in FIG. 21, an outer wall of the flow equalization block 560 is provided with a plurality of first grooves 563 and a second groove 564. The plurality of first grooves 563 extend along the axial direction of the flow equalization block 560. The second groove 564 is an annular groove distributed along the circumferential direction of the flow equalization block 560. The second groove 564 is provided on a side of the flow equalization block 560 away from the second protection assembly 400. Each first groove 563 is interconnected with the second groove 564. The first groove 563 and the second groove 564 have a semi-circular cross-section. The flow equalization block 560 is sealingly connected with the first sleeve 510. The inner wall of the first sleeve 510 covers groove openings of the first grooves 563 and the second groove 563 to form the plurality of second gas channels 562. The first gas channel 550 is interconnected with the second groove 564.

It can be understood that the gas flowing out of the first gas channel 550 is buffered by the second groove 564 before entering the first grooves 563, reducing the air pressure loss, so that the air pressure in each first groove 563 is the same, achieving a good pressure equalization effect.

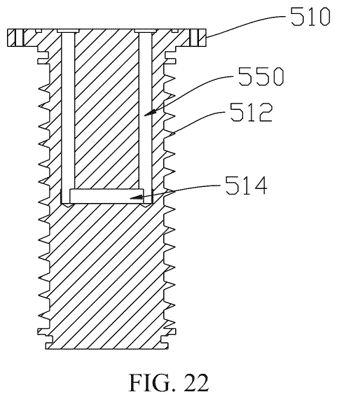

As shown in FIG. 22, the inner wall of the first sleeve 510 is provided with a third groove 514. The third groove 514 is close to the first light-transmitting and gas blowing channel 511. The third groove 514 is connected with an outlet of the first gas channel 550. A groove opening of the third groove 514 is opposite to the groove opening of the second groove 564, so that the third groove 514 and the second groove 564 form an annular channel to reduce air pressure loss.

In some embodiments, as shown in FIG. 20, the nozzle blowing assembly 500 further includes a gas blowing cover 570. The gas blowing cover 570 is an annular disc structure, and is disposed in the first housing 520. The gas blowing cover 570 is connected with the first housing 520 through a pin shaft. The gas blowing cover 570 is disposed on a side of the first sleeve 510 close to the optical module 300. The gas blowing cover 570 and the first sleeve 510 are sealingly connected through a sealing ring. A first communication groove 571 is provided on a side of the gas blowing cover 570 away from the flow equalization block 560. The first communication groove 571 is arc-shaped. The first communication groove 571 is connected with gas inlets of multiple first gas channels 550. For example, the gas inlets of two first gas channel 550 share a single first communication groove 571. Optionally, the gas inlets of four first gas channel 550 share a single first communication groove 571. Gas inlet ends of the first gas channels 550 are connected through the gas blowing cover 570 to realize simultaneous gas intake into the first gas channels 550 to ensure the pressure equalization effect.

In some embodiments, as shown in FIGS. 20 and 22, the outer surface of the first sleeve 510 is provided with one or more helically arranged fins 512. The fins 512 are sealingly connected with an inner surface of the first housing 520. The first heat dissipation channel(s) 530 is defined by the helical fin (or adjacent fins) 512, the outer surface of the first sleeve and the inner surface of the first housing 520. The helical first heat dissipation channel 530 increases a length of the heat dissipation channel and improves the heat dissipation effect.

In the above embodiments, the surface of the first sleeve 510 has two helically arranged fins 512. The two fins 512 have a same helical direction. Two helical first heat dissipation channels 530 are formed between the first sleeve 510 and the first housing 520. The length of the heat dissipation channel is further increased to improve the heat dissipation effect. In addition, even if one of the first heat dissipation channels 530 is blocked, the other one can still circulate the gas, ensuring the reliability of heat dissipation.

In some embodiments, as shown in FIGS. 20 and 21, the first housing 520 includes a cone 526 and a ceramic ring 527. The cone 526 is sleeved on the first sleeve 510. The cone 526 and the first sleeve 510 are sealingly connected to form the first heat dissipation channel 530. A side of the cone 526 close to the second protection assembly 400 is provided with a flange connection part. The cone 526 is detachably connected with the second protection assembly 400 through a pin shaft. A part of the cone 526 close to the nozzle 540 is cylindrical. The ceramic ring 527 is connected with the nozzle 540. The cooling gas channel 521 is arranged to extend through the cone 526 and the ceramic ring 527. The first gas outlet 524 is provided on a side of the ceramic ring close to the nozzle 540.

It can be understood that the cooling gas channel 521 blows cold gas directly to the nozzle 540 through the ceramic ring 527, thereby reducing heat loss and improving the cooling and heat dissipation effect of the nozzle 540.

Based on the above embodiments, as shown in FIGS. 19, 20 and 21, the first housing 520 further includes a first adapter block 528 disposed between the cone 526 and the ceramic ring 527. The adapter block 528 connects the cone 526 and the ceramic ring 527. The ceramic ring 527 is connected with the first adapter block 528 through a connection screw sleeve 529. The cooling gas channel 521 is arranged inside and extending through the cone 526, the adapter block 528, and the ceramic ring 527. The first housing 520 is assembled with several separate structures and may be installed and disassembled for easy maintenance.

The cooling gas channel 521 includes a first sub-section, a second sub-section, a third sub-section, and a fourth sub-section. The first sub-section extends along an axis of the cone 526. The second sub-section is in a shape of a long groove which is disposed on a side of the first adapter block 528 facing the cone 526. One end of the second sub-section is connected with the first sub-section, and the other end of the second sub-section is connected with the third sub-section. The third sub-section is arranged in the first adapter block 528, and is bent. The fourth sub-section is arranged in the ceramic ring 527. A side surface of the ceramic ring 527 facing the nozzle 540 is provided with the first gas outlet 524 in an annular groove shape. Through the annular first gas outlet 524 blowing gas to the nozzle 540, a large blowing area is obtained, which is beneficial to the heat dissipation of the nozzle 540.

In some embodiments, as shown in FIGS. 1, 2 and 3, the first protection assembly 200 includes a first mounting base 210, a first protection lens 220, and an aperture 230. The first mounting base 210 is connected with the optical fiber connector 100, the first protection lens 220 and the aperture 230 are installed in the first mounting base 210, and the first protection lens 220 is closer to the optical fiber connector 100 than the aperture 230 to the optical fiber connector 100.

In some embodiments of the present disclosure, the first protection lens 220 has a dust-proof function to prevent dust from entering the optical module 300 on a rear side of the first protection assembly 220. The aperture 230 is provided in the first mounting base 210 to block light. The first mounting base 210 integrates the first protection lens 220 and the aperture 230 to form the first protective component 200, which facilitates overall installation and disassembly of the first protective component 200 and improves module maintainability.

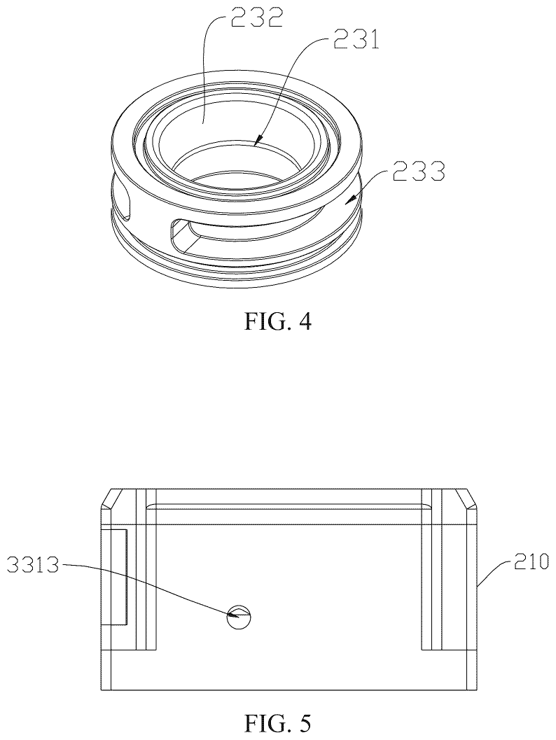

In some embodiments, as shown in FIG. 4, the aperture 230 represents a cylindrical structure, and includes a first light-transmitting channel 231. An inner wall of the first light-transmitting channel 231 is provided with a light blocking surface 232. The light blocking surface 232 is close to the first protection lens 220. The light blocking surface 232 is in a shape of a trumpet. A diameter of one end of the light blocking surface 232 close to the first protection lens 220 is larger than a diameter of the other end of the light blocking surface 232. The light blocking surface 232 blocks light and has a large light-blocking area.

In some embodiments, the light blocking surface 232 is provided with a black high-temperature resistant coating layer. The black high-temperature resistant coating layer can withstand a temperature of 1400 °C, which improves the high-temperature resistant performance of the aperture 230.

In some embodiments, the black high-temperature resistant coating layer is roughened, which increases a laser absorption rate of the light blocking surface 232 and reduces laser reflection, preventing scattered light from being caused by laser reflection, and making the aperture 230 more stable.

In some embodiments, as shown in FIGS. 2 and 3, an outer surface of the aperture 230 is sealingly connected with an inner surface of the first mounting base 210. A second heat dissipation channel 240 is provided between the aperture 230 and the first mounting base 210. The first mounting base 210 is provided with a second inlet 241 and a second outlet 242. The second inlet 241 and the second outlet 242 are respectively connected with the second heat dissipation channel 240.

The second heat dissipation channel 240 is used to dissipate heat of the aperture 230 to avoid a physical damage to the aperture 230 caused by excessive temperature of the aperture 230, to further prevent the heat from being transferred to the lower optical module 300, protecting the optical module 300 and improving the reliability of the laser cutting head.

Based on the above embodiments, as shown in FIG. 4, the outer surface of the aperture 230 is provided with a fourth groove 233, the aperture 230 is sealingly connected with the first mounting base 210, and the fourth groove 233 and an inner wall of the first mounting base 210 together define the second heat dissipation channel 240. The fourth groove 233 is a non-closed annular shape. The second inlet 241 is provided at one end of the fourth groove 233, and the second outlet 242 is provided at the other end of the fourth groove 233, increasing an area of the second heat dissipation channel 240 as much as possible to improve the heat dissipation effect.

Based on the above embodiments, as shown in FIGS. 3 and 6, the first protection assembly 200 further includes a first lens base 250, the first protection lens 220 is installed on the first lens base 250, and the first lens base 250 is installed on the first mounting base 210 in a drawer-type manner, which facilitates replacement and disassembly of the first lens base 250.

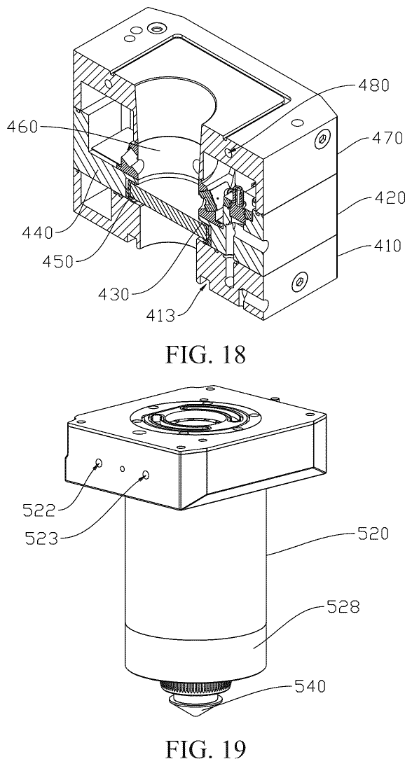

In some embodiments, as shown in FIGS. 17 and 18, the second protection assembly 400 includes a lower mounting base 410, an upper mounting base 420, a second protection lens 430, a second lens base 440, and a seal 450. The lower mounting base 410 is arranged to be opposite to and is detachably connected with the upper mounting base 420. The second protection lens 430 is installed on the second lens base 440. The second lens base 440 is fixed between the lower mounting base 410 and the upper mounting base 420. The seal 450 is located between the second protection lens 430 and the lower mounting base 410, and sealingly connects the second protection lens 430 and the lower mounting base 410. The modular second protection assembly 400 facilitates the installation and disassembly of the second protection assembly 400 and facilitates operation.

It can be understood that the gas outlet of the second gas channel 562 faces the second protection assembly 400, and the gas discharged from the second gas channel 562 is sprayed towards the second protection assembly 400. The second protection assembly 400 is designed to be a sealed structure. The gas hits the second protection assembly 400 and turns rearward and flows into the second light-transmitting and gas blowing channel 561 below to achieve pressure equalization.

Based on the above embodiments, as shown in FIG. 18, the seal 450 is a spring seal (or spring energized seal). The spring seal is located in the second lens base 440. One side of the spring seal is attached to the second protection lens 430, and the other side of the spring seal is attached to a top of the lower mounting base 410.

It can be understood that the gas outlet of the second gas channel 562 blows gas to the second protection assembly 400. After the spring seal is inflated, two sides of the spring seal fit more closely with the second protection lens 430 and the lower mounting base 410. The greater the gas pressure, the better the sealing effect.

Based on the above embodiments, as shown in FIG. 18, the upper mounting base 420 is provided therein with a monitoring mounting plate 460, and the monitoring mounting plate 460 is provided with a temperature sensor, a gas pressure sensor, and a photosensitive sensor.

Based on the above embodiments, as shown in FIGS. 1 and 17, the lower mounting base 410 is provided with a first gas inlet 411 and a second gas inlet 412. A side of the lower mounting base 410 facing the gas blowing cover 570 is provided with a second communication groove 413, and the second communication groove 413 corresponds to the first communication groove 571. The first gas inlet 411 is connected with the second communication groove 413, the second communication groove 413 is interconnected with the first communication groove 571, thereby achieving a connection between the first gas inlet 411 and the first light-transmitting and gas blowing channel 511, and a connection between the second gas inlet 412 and the cooling gas channel 521.

As a modification, the first gas inlet 411 and the second gas inlet 412 may be directly provided on the nozzle blowing assembly 500 to achieve gas intake.

In some embodiments, as shown in FIG. 18, the second protection assembly 400 further includes a second adapter block 470 disposed on a side of the upper mounting base 420 away from the lower mounting base 410. The second adapter block 470 connects the optical module 300 and the lower mounting base 410. A plurality of second adapter blocks 470 may be provided according to a focusing distance of the focusing assembly 320. The second adapter block 470 is provided with a fifth heat dissipation channel 480. The fifth heat dissipation channel 480 cools and dissipates heat for the focusing assembly 320, thereby improving the heat dissipation effect of the optical module 300.

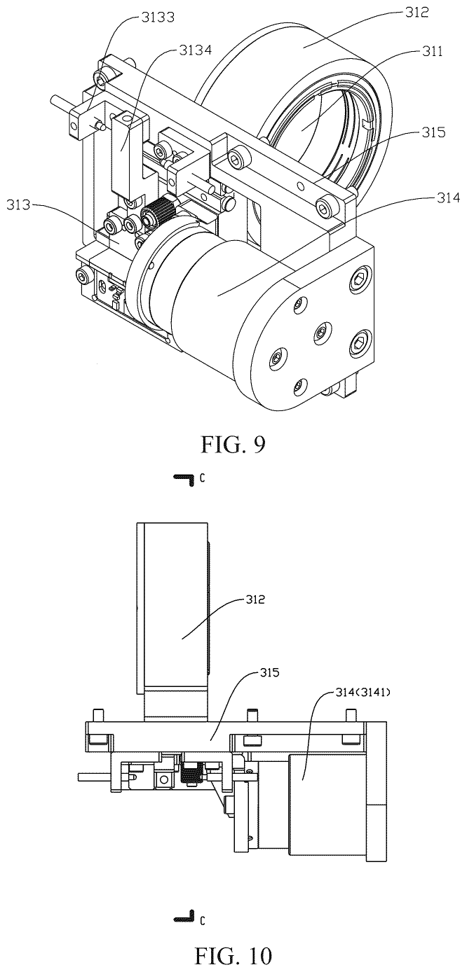

Based on the above embodiments, as shown in FIGS. 9 to 13, the collimation assembly 310 includes a collimation lens 311, a collimation lens base 312, a sliding mechanism 313, and a driving mechanism 314. The collimating lens 311 is installed in the collimation lens base 312. The sliding mechanism 313 may adopt a standard guiding rail module to reduce an installation difficulty, improve structural stability, accuracy, load-bearing capacity, and improve structural maintainability, interchangeability, and stability. The sliding mechanism 313 includes a guiding rail 3131 and a sliding block 3132. The collimation lens base 312 is fixedly connected with the sliding block 3132. The driving mechanism 314 is connected with the sliding block 3132. The driving mechanism 314 drives the sliding block 3132 to move, and the sliding block 3132 drives the collimation lens base 312 to move close to or away from the first protection assembly 200 to realize automatic adjustment of the collimation lens 311. The automatic adjustment has high precision and an adjustment operation is simple.

The collimation assembly 310, adopting a modular design and as a separate functional module in the entire cutting head, is easy to disassemble and assemble, and is reliable and maintainable. The module of the collimation assembly 310 and a housing of the cutting head are designed with a quick-release structure, which is convenient to maintain and replace the collimation lens.

Based on the above embodiments, as shown in FIG. 9, the sliding mechanism 313 further includes two limiters 3133 and a limiter fitting component 3134. Each limiter 3133 is a blocking post, and the limiter fitting component 3134 is a baffle. The limiter fitting component 3134 is provided on the sliding block 3132, the two limiters 3133 are spaced apart, and the limiter fitting component 3134 is located between the two limiters 3133. When the driving mechanism 314 drives the sliding block 3132 to move, the limiter fitting component 3134 is driven to move until the limiter fitting component 3134 contacts one of the limiters 3133, where the collimation lens 311 reaches the extreme position.

In some embodiments, as shown in FIGS. 9 and 13, the collimation assembly 310 further includes a fixing bracket 315. The fixing bracket 315 is provided on the second housing 330, and the driving mechanism 314 is installed on the fixing bracket 315.

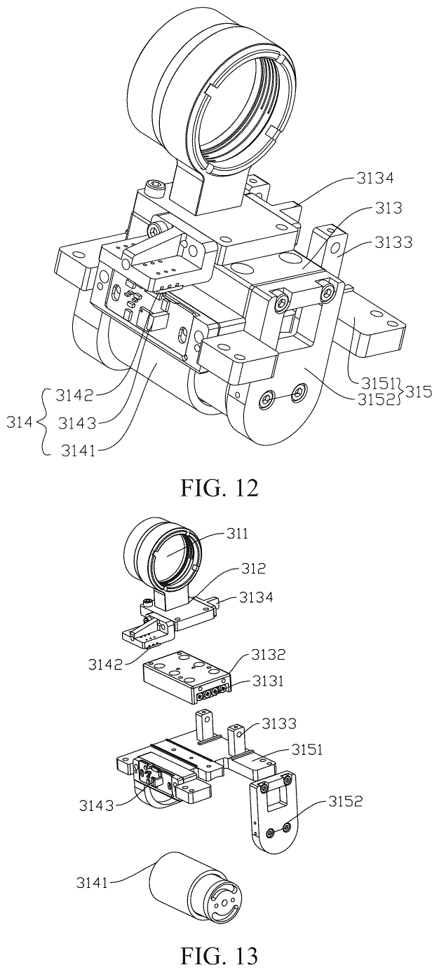

In some embodiments, as shown in FIGS. 9 and 12, the driving mechanism 314 includes a voice coil motor 3141. The voice coil motor 3141 is connected with the sliding mechanism 313. The voice coil motor 3141 is used to drive the collimation lens base 312 to move close to or away from the first protection assembly 200. The voice coil motor has large torque, strong load-bearing capacity, and fast acceleration, and allows the collimation lens 311 to quickly complete the adjustment action, thereby realizing fast zoom time, a small size, and a compact structure.

In some embodiments, as shown in FIG. 12, the driving mechanism 314 further includes a magnetic scale 3142 and a sensing component 3143. The sensing component 3143 is signal-connected to the voice coil motor 3141. The sensing component 3143 is opposite to the magnetic scale 3142. The sensing component 3143 is fixedly arranged. The magnetic scale 3142 is connected with the collimation lens base 312. The sensing component 3143 and the magnetic scale 3142 move relative to each other.

It can be understood that through the cooperation of the magnetic scale 3142 and the sensing component 3143, a moving distance of the collimation lens 311 can be accurately calculated, and hence a precise adjustment of the collimation lens 311 can be achieved.

As shown in FIG. 12, the fixing bracket 315 includes a motor fixing plate 3151 and a coil fixing plate 3152. The motor fixing plate 3151 is fixedly connected with the second housing 330. The voice coil motor 3141 is fixed on a side of the motor fixing plate 3151, and the coil fixing plate 3152 is fixed on a coil end of the voice coil motor 3141, the coil fixing plate 3152 is fixedly connected with the sliding block 3132, and the limiters 3133 are provided on the motor fixing plate 3151. There is a quick-release modular structure between the collimation assembly 310 and the second housing 330 to facilitate the maintenance of the collimation lens 311. When the collimation lens 311 is damaged, it may simply dismantle the collimation assembly 310 as a whole to improve the maintainability of the product. In addition, the collimation lens 311 and the collimation lens base 312 each has a standardized module structure. During the maintenance of the collimation lens 311, one may simply replace the standardized module, making the installation and maintenance simple.

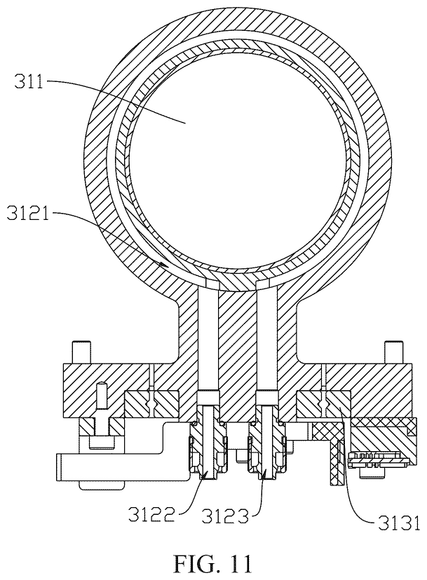

In some embodiments, as shown in FIGS. 10 and 11, a third heat dissipation channel 3121, a third inlet 3122, and a third outlet 3123 are provided in the collimation lens base 312. The third inlet 3122 and the third outlet 3123 are connected with the third heat dissipation channel 3121.

It can be understood that in the embodiments of the present disclosure, by separately configuring the third heat dissipation channel 3121 in the collimation lens base 312, the heat of the collimation lens 311 may be directly dissipated, preventing the collimation lens 311 from being burned, and ensuring that the collimation lens 311 is safe and reliable, which therefore makes the collimation lens 311 more suitable for high-power laser cutting applications.

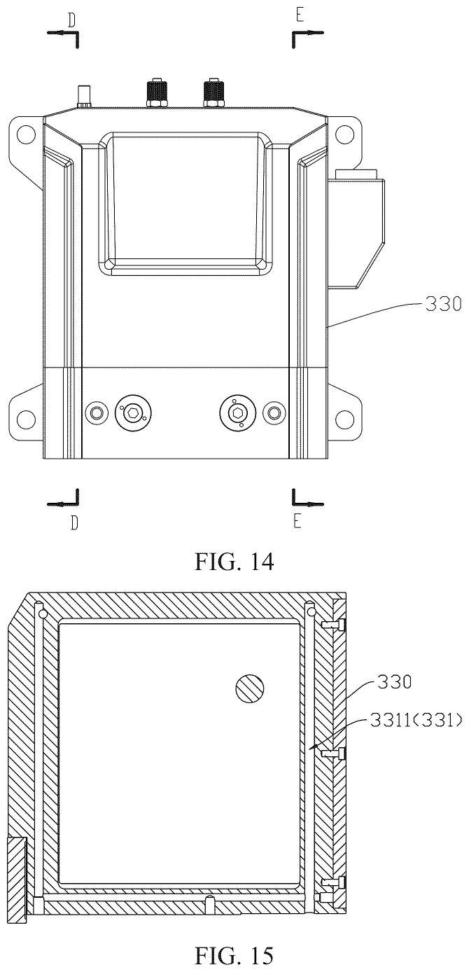

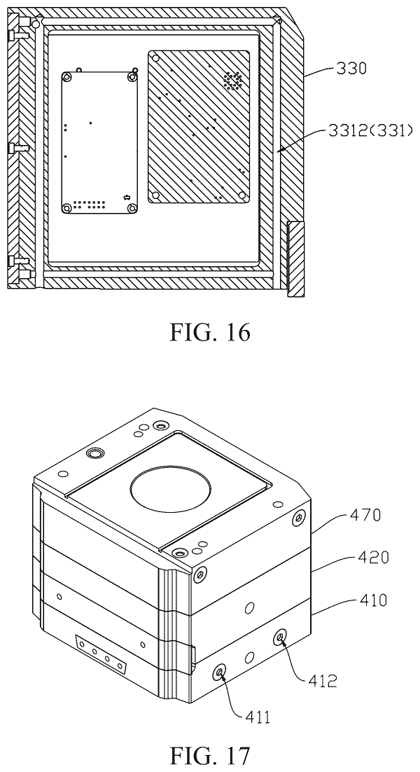

In some embodiments, as shown in FIGS. 14, 15, and 16, a fourth heat dissipation channel 331 is provided in the second housing 330. The fourth heat dissipation channel 331 is interconnected with the fifth heat dissipation channel 480, and the fourth heat dissipation channel 331 extends nearby side and top surfaces of the second housing 330.

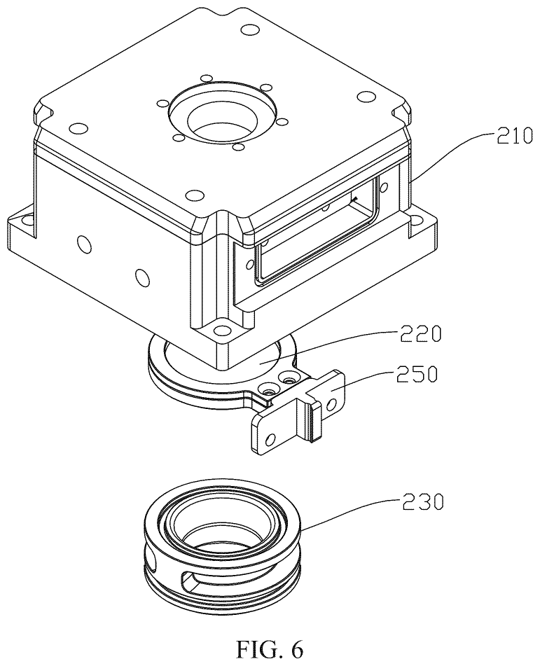

Referring to FIGS. 5, 14, 15, and 16, the fourth heat dissipation channel 331 includes a water inlet channel 3311, a water outlet channel 3312, and a fourth inlet 3313. The fourth inlet 3313 is provided on the first mounting base 210, and the water inlet channel 3311 is provided on one side of the second housing 330, and the water outlet channel 3312 is provided on the other side of the second housing 330, wherein the two sides of the second housing 330 are opposite to each other. The water inlet channel 3311 and the water outlet channel 3312 are interconnected with the fifth heat dissipation channel 480. The water outlet channel 3312 and the second heat dissipation channel 240 share the second outlet 242, realizing integration of pipelines and reducing openings.

In the above embodiments, each embodiment has its own emphasis in description. For parts that are not described in detail in a certain embodiment, please refer to the relevant descriptions of other embodiments.

In the description of the present disclosure, the terms “first” and “second” are used for descriptive purposes only, and cannot be understood as indicating or implying relative importance or implicitly indicating the number of indicated technical features. Therefore, the features defined as “first” and “second” may explicitly or implicitly include one or more features.

The laser cutting head provided by some embodiments of the present application has been introduced in detail above. Specific examples are used in this description to illustrate the principles and implementation methods of the present application. The description of the above embodiments is only used to help understand the method of the present application and its core idea. Meanwhile, for those skilled in the art, there will be changes in the specific implementation and application scope based on the ideas of the present application. In summary, the content of this description should not be understood as a limitation of the present application.

1. A laser cutting head, comprising an optical fiber connector, a first protection assembly, an optical module, a second protection assembly, and a nozzle blowing assembly that are connected in sequence, wherein the nozzle blowing assembly comprises:
a first sleeve provided with a first light-transmitting and gas blowing channel;
a first housing sleeved on the first sleeve, wherein a first heat dissipation channel is formed between the first housing and the first sleeve, the first housing is provided with a cooling gas channel, a first inlet, a first outlet, and a first gas outlet, the first inlet and the first outlet are connected with the first heat dissipation channel, and the first gas outlet is connected with the cooling gas channel;
a nozzle connected with the first housing, wherein the first light-transmitting and gas blowing channel is connected with the nozzle, and the first gas outlet is located on a side of the first housing adjacent to the nozzle;
a flow equalization block, wherein:
the flow equalization block is adapted to a mounting hole provided inside the first sleeve, the flow equalization block is cylindrical, the flow equalization block is installed in the first sleeve,
a second light-transmitting and gas blowing channel is arranged in the flow equalization block, the second light-transmitting and gas blowing channel is interconnected with the first light-transmitting and gas blowing channel,
a plurality of second gas channels are formed between an outer wall of the flow equalization block and an inner wall of the first sleeve, each second gas channel extends along an axial direction of the first sleeve, the plurality of second gas channels are arranged at an interval along a circumferential direction of the flow equalization block,
the first sleeve is provided with a plurality of first gas channels, a gas inlet of each first gas channel faces the second protection assembly, a gas outlet of each second gas channel faces the second protection assembly, a gas outlet of each first gas channel is connected with the second gas channels, and the gas outlet of each second gas channel is connected with the second light-transmitting and gas blowing channel; and
a gas blowing cover arranged in the first sleeve and located on a side of the flow equalization block away from the nozzle, wherein the gas blowing cover is connected with an end of the first sleeve away from the nozzle, a first communication groove is provided on a side of the gas blowing cover away from the flow equalization block, and the first communication groove is interconnected with the gas inlets of two or more of the plurality of first gas channels.

2. The laser cutting head according to claim 1, wherein the outer wall of the flow equalization block is provided with a plurality of first grooves and a second groove,
the plurality of first grooves extend along an axial direction of the flow equalization block, the second groove is distributed along a circumferential direction of the flow equalization block and is provided on a side of the flow equalization block away from the second protection assembly,
each first groove is interconnected with the second groove, each first gas channel is interconnected with the second groove, and
the flow equalization block is sealingly connected with the first sleeve, such that the inner wall of the first sleeve covers groove openings of the first grooves and the second groove to form the plurality of second gas channels.

3. The laser cutting head according to claim 1, wherein an outer surface of the first sleeve is provided with one or more helically arranged fins, and each fin is sealingly connected with the first housing to form the first heat dissipation channel.

4. The laser cutting head according to claim 1, wherein the first housing comprises:
a cone sleeved on the first sleeve, wherein the first heat dissipation channel is formed between the cone and the first sleeve; and
a ceramic ring provided on a side of the cone away from the second protection assembly, wherein the ceramic ring is connected with the nozzle, the cooling gas channel is arranged inside and extending through the cone and the ceramic ring, and the first gas outlet is provided on a side of the ceramic ring adjacent to the nozzle.

5. The laser cutting head according to claim 4, wherein the first housing further comprises a first adapter block disposed between the cone and the ceramic ring, the first adapter block connects the cone and the ceramic ring, and the cooling gas channel is arranged inside and extending through the cone, the adapter block, and the ceramic ring.

6. The laser cutting head according to claim 1, wherein the first protection assembly comprises a first mounting base, a first protection lens, and an aperture, the first mounting base is connected with the optical fiber connector, the first protection lens and the aperture are installed in the first mounting base, and the first protection lens is closer to the optical fiber connector than the aperture to the optical fiber connector.

7. The laser cutting head according to claim 6, wherein the aperture comprises a first light-transmitting channel, an inner wall of the first light-transmitting channel is provided with a light blocking surface, the light-blocking surface is adjacent to the first protection lens, and
the light-blocking surface is provided with a black high-temperature resistant coating layer, and the black high-temperature resistant coating layer is roughened.

8. The laser cutting head according to claim 7, wherein the aperture is connected with the first mounting base to form a second heat dissipation channel, the first mounting base is provided with a second inlet and a second outlet, and the second inlet and the second outlet are respectively connected with the second heat dissipation channel.

9. The laser cutting head according to claim 1, wherein the optical module comprises:
a second housing, wherein the second housing is connected with the first protection assembly and the second protection assembly;
a collimation assembly installed in the second housing; and
a focusing assembly installed in the second housing, wherein the collimation assembly is closer to the first protection assembly than the focusing assembly to the first protection assembly.

10. The laser cutting head according to claim 9, wherein the collimation assembly comprises:
a collimation lens;
a collimation lens base, wherein the collimation lens is installed in the collimation lens base;
a sliding mechanism comprising a guiding rail and a sliding block, wherein the collimation lens base is fixedly connected with the sliding block; and
a driving mechanism connected with the sliding block, wherein the driving mechanism is configured to drive the sliding block to drive the collimation lens base to move close to or away from the first protection assembly.

11. The laser cutting head according to claim 10, wherein the collimation assembly further comprises a fixing bracket, the fixing bracket is on the second housing, and the driving mechanism is installed on the fixing bracket.

12. The laser cutting head according to claim 10, wherein the driving mechanism comprises a voice coil motor connected with the sliding block.

13. The laser cutting head according to claim 12, wherein the driving mechanism further comprises a magnetic scale and a sensing component, the sensing component is signal-connected to the voice coil motor, the sensing component is opposite to the magnetic scale, the sensing component is fixedly arranged, and the magnetic scale is connected with the collimation lens base.

14. The laser cutting head according to claim 10, wherein the sliding mechanism further comprises two limiters and a limiter fitting component, the limiter fitting component is provided on the sliding block, the two limiters are spaced apart, the limiter fitting component is located between the two limiters, and the limiter fitting component moves between the two limiters along with the sliding block.

15. The laser cutting head according to claim 10, wherein a third heat dissipation channel, a third inlet, and a third outlet are provided in the collimation lens base, and the third inlet and the third outlet are connected with the third heat dissipation channel.

16. The laser cutting head according to claim 9, wherein a fourth heat dissipation channel is provided in the second housing, a fourth inlet and a second outlet are provided on the first protection assembly, and the fourth heat dissipation channel is connected with the fourth inlet and the second outlet.

17. The laser cutting head according to claim 1, wherein the second protection assembly comprises: a lower mounting base, an upper mounting base, a second protection lens, a second lens base, and a seal,
the lower mounting base is arranged to be opposite to the upper mounting base,
the second protection lens is installed on the second lens base which is fixed between the lower mounting base and the upper mounting base,
the seal is located between the second protection lens and the lower mounting base, and sealingly connects the second protection lens and the lower mounting base, and
the lower mounting base is provided with a first gas inlet and a second gas inlet, the first gas inlet is connected with the first communication groove, and the second gas inlet is connected with the cooling gas channel.

18. The laser cutting head according to claim 17, wherein the seal is a spring seal, the spring seal is located in the second lens base, one side of the spring seal is attached to the second protection lens, and the other side of the spring seal is attached to a top of the lower mounting base.

19. The laser cutting head according to claim 17, wherein the second protection assembly further comprises a second adapter block disposed on a side of the upper mounting base away from the lower mounting base, the second adapter block connects the optical module, and a fifth heat dissipation channel is provided in the second adapter block.

20. The laser cutting head according to claim 17, wherein the first gas inlet is connected with the first light-transmitting and gas blowing channel.
